(19) United States
(12) Patent Application Publication
(10) Pub. No.: US 2010/0085755 A1
(43) Pub. Date: Apr. 8, 2010

(54) Modular backlighting device

(75) Inventor: Angel Sanabra Cunill, Barcelona (ES)

Correspondence Address: D. PETER HOCHBERG CO. L.P.A., 1940 EAST 6TH STREET, CLEVELAND, OH, 44114, US

(73) Assignee: Sakma Electronica Industrial, S.A., Barcelona (ES)

(21) Appl. No.: 12/311,478

(22) PCT Filed: Sep. 26, 2007
(86) PCT No.: PCT/EP2007/008371

§ 371 Date: Nov. 20, 2009

(30) Foreign Application Priority Data
Sep. 28, 2006 (ES) U200602189

(51) Int. Cl. F21S 4/00

(52) U.S. Cl. 362/249.06; 362/249.02

(57) ABSTRACT

This device includes boards housing a large number of LEDs electrically connected with the tracks of a printed circuit, arranged in the board according to an equilateral triangular distribution and separated from one another at a fixed distance ‘a’, these light emitting diodes project beams of light interlacing from a certain distance ‘d’ of the board, giving even mass of light to the device at the above mentioned distance ‘d’, without points or appreciable zones of shadow. The boards are equipped with interlocking sections on both edges which are used as a guide for centering for the side connection of successive boards, as in a jigsaw puzzle, and the formation of a lighting panel having a larger surface.

This application is a National Stage application of International Application No. PCT/EP2007/008371, filed on Sep. 26, 2007 and claims priority of Spanish Application Serial No. U200602189 filed Sep. 28, 2006.

### BACKGROUND OF THE INVENTION

1. Field of the Invention

The present invention refers to a modular backlighting device of the type which includes various lighting elements arranged on a panel or support board, to illuminate a large or small surface.

2. Description of the Prior Art

At present, the use of different lighting elements, such as fluorescent tubes, halogen lamps, incandescent bulbs or high power LEDs is very common for the lighting of surfaces and different spaces. These lighting elements, used independently, illuminate a reduced or particular space; however, there are many applications which seek to illuminate spaces or large surfaces as evenly as possible and to minimise the shaded areas. This type of lighting is especially suitable in photographic studios, lighting of posters and signs, light boxes, art galleries, and in other applications in which illumination is, either direct, or from the back when the surface being illuminated is translucent. Presently, to achieve as even lighting as possible, lighting panels are used, which consist of a support board on which various lighting elements are mounted, usually fluorescent tubes, arranged in a parallel fashion and spaced evenly. These fluorescent panels do not provide even lighting across the surface with more light visible around the areas where the fluorescent tubes are housed and other darker areas in the middle section. To solve this problem two compromise solutions exist. The first solution is to increase the number of fluorescent tubes in the panel, so that they are closer to one another, offering more even light, however this increases energy consumption. Another solution is the placement above the fluorescent tubes of a diffuser distanced sufficiently from the fluorescent tubes, so that a larger diffusion of light is obtained and less contrast between the lighter and darker areas. This solution produces a noticeable decrease in intensity, meaning that more fluorescent tubes of higher intensity and consumption have to be fitted.

In some cases the means of lighting can be neon and even light emitting diodes (LEDs) distributed in square matrixes. Another type of lighting panel known and used especially in signs to provide more even light is for a transparent metacryolite board provided with a few channels arranged in bas-relief and illuminated, at least, at one end by an alignment of LEDs whose light falls on the walls of the channels defined in the lateral surface of the board projecting it towards the front area. This type of panels have many disadvantages, among which it is necessary to emphasize the need to use a high number of LEDs, very close to one another, forming the end alignments, which cause problems of dissipation of heat and an important reduction of the useful life of the LEDs, or the limitation of the dimensions of the board to obtain suitable lighting, since the light projected from the side attenuates as it travels from the source, causing poor or uneven light at short distances (up to 50 cm).

### SUMMARY OF THE INVENTION

The modular backlighting device object of this invention presents various particular features designed to allow the conformation of a lighting panel without dimensional limitations and to provide even lighting without appreciable shadows or dark areas.

This modular backlighting device is applicable both in direct lighting and in lighting from behind or backlighting of panels or surfaces or translucent bodies.

In accordance with the invention, the modular device comprises an unspecified number of printed circuit boards of equal size to which are connected a large number of light emitting diodes arranged according to an equilateral triangular matrix and separated from one another at a fixed distance “a”. Each of the boards is equipped with various interlocking slot sections on both edges which are used as a guide for centring and enabling the attachment of successive boards, as in a jigsaw puzzle, so that larger lighting panels can be created.

The triangular equilateral distribution of the light emitting diodes in the boards determines that the beams of light emitted by said diodes converge at a certain distance “d” of the board providing from the above mentioned distance a surface or even mass of light without points or appreciable zones of shade.

The distance “d” from which the device provides even lighting without shadow depends on the distance “a” existing between the light emitting diodes and on the aperture or angle of the beam of light emitted by the diodes, therefore the mentioned distance “d” can be reduced using diodes with a larger angle of aperture or reducing the existing separation between said diodes, that is to say the distance “a”.

The possibility of reducing the distance “d”, from which the device provides even light (without shadows) provides this lighting device with some ideal characteristics for those applications in which it is necessary to project uniform lighting onto posters, signs, photographs or any translucent element, and in areas of reduced space or limited end section.

The housing boards of the light emitting diodes have various openings for assembly and rapid attachment to any surface by means of clamps, screws or any other conventional means.

One of the characteristics of the device is that the light emitting diodes are arranged in the boards in such a way that on having done the panelling or side connection of successive boards, the light emitting diodes of the above mentioned boards support the triangular equilateral distribution and the distance “a” between said diodes, which allows the creation of much larger lighting surfaces of completely even light, without shadows or areas of deficient lighting in the joints of the successive boards.

The boards have connectors or contact points for the interconnection of the respective circuits printed in the position of connecting or panelling and the simultaneous supply to all of the boards in the device.

In accordance with the invention, the boards can have tear lines, defined by pre scored areas, to allow a controlled separation of the board and to obtain smaller sizes of the board, of varying dimensions which can be used independently or connected to a panel formed by two or more interconnected boards. The above mentioned tear lines are arranged in such a way that each of the portions obtained by the separation of the board will have a group of light emitting diodes connected electrically by the conductive tracks of the printed circuit. The portions of board obtained by means of controlled separation at the tear lines allow a better dimensional adjustment of the lighting device within the space or available surface in every specific application.

### BRIEF DESCRIPTION OF THE DRAWINGS

To complement the description being undertaken and in order to ease understanding of the characteristics of the invention, the present description contains a set of drawings in which, with illustrative and not limitative character, the following has been represented:

FIG. 1 shows a schematic elevated view from the front of the device comprising a lighting panel containing four housing boards of light emitting diodes, connected side by side and in which it is possible to observe the conservation of the triangular equilateral arrangement of the light emitting diodes in the connecting areas of the boards.

FIG. 2 shows a schematic elevated view of one of the boards in FIG. 1, provided in this case with score lines for the controlled separation of the board into usable pieces of various sizes.

FIG. 3 shows a front elevated view of an example of embodiment of one of the boards, in which the printed connecting circuit board is represented.

FIG. 4 shows a schematic, partial side view of one of the boards in which the beams of light emitted by one of the rows of diodes are represented. This figure shows the beams of light that illuminate a point arranged to a distance “d” of the front of the board as a continuous line, and the adjacent beams of light that do not illuminate the mentioned point are represented as broken lines.

FIG. 5 represents a front view of the beams of light emitted by the diodes of one of the boards which are cut at a distance “d” by a cross-section parallel to the board, the above mentioned board provides even light, as can be seen in this figure, the effect of the beams of light of four of the diodes on the point of reference represented in the previous figure.

FIG. 6 shows an analogous view to the FIG. 4, in which the beams of light are represented as continuous lines which converge on a point placed to a distance “d1” of the board.

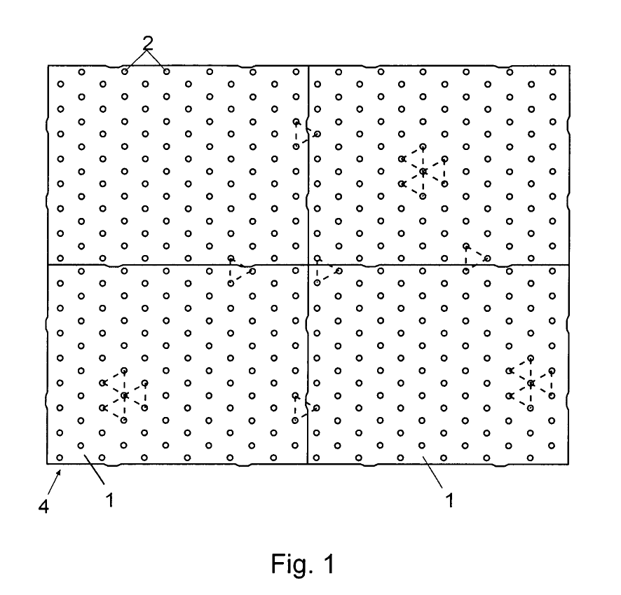

### DETAILED DESCRIPTION OF THE PREFERRED EMBODIMENT

As can be observed in the indexed figures, the device includes an indeterminate number of boards (1) all equal, each being housings of light emitting diodes (2) arranged according to a triangular equilateral distribution, separated at distance “a” and connected electrically with conductive tracks to a printed circuit (3).

The light emitting diodes (2) project beams of light towards the front of the board which, from a distance “d”, overlap or interlace partially, providing even and uniform lighting which lacks both shadows and dark areas. The distance “d”, as previously mentioned, depends on the angle of aperture of the beam of light emitted by the light emitting diodes and on the separation “a” existing between said light emitting diodes (2).

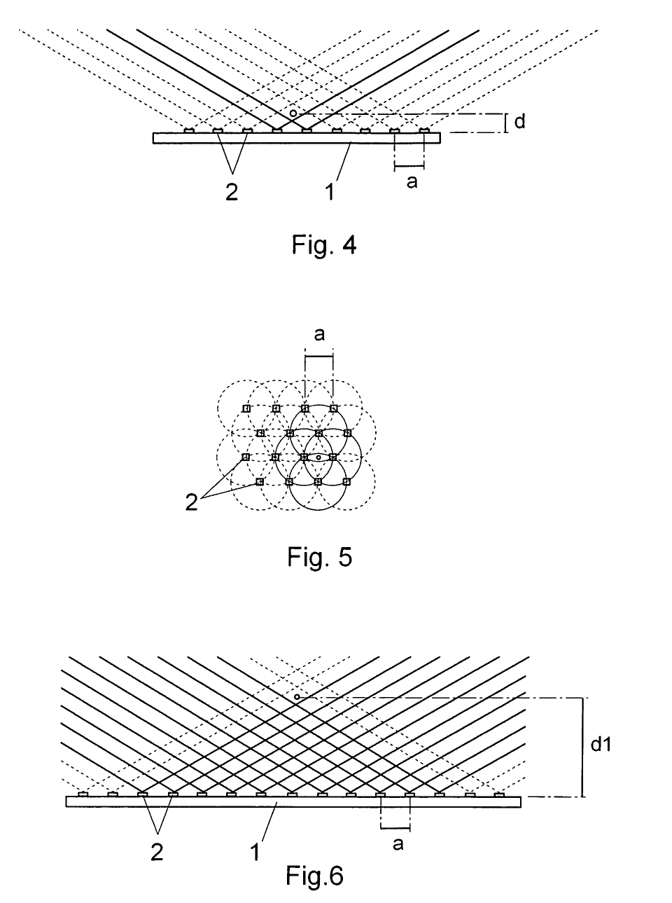

As can be observed in FIGS. 4 and 5, any point arranged to an equal distance or over in relation to “d” is lit by, at least, three light emitting diodes which provide uniformity in the entire surface being lit.

As the distance “d” is increased, as shown in FIG. 6, in which a point above distance “d1” is represented, the number of light emitting diodes (2) that light every point increases progressively, which allows for even lighting and prevents excessive loss of brightness owed precisely to the increase of the number of light emitting diodes (2) lighting the same point.

The boards (1) contain interlocking slot sections (11) (12) at their outer edges that allow for correct alignment of successive boards (1) to form a lighting panel (4) with a larger surface. The placement of the diodes (2) in each of the boards is such that, on connecting two boards (1), the diodes (2) of the above mentioned boards maintain the triangular equilateral distribution at the joining section and the separation “a”, avoiding the formation of shadows or areas of deficient lighting.

The above mentioned boards (1) also include openings (13) for the assembly of clamps, screws or similar means of attachment to any suitable surface. The printed circuits (3) of each one of the boards (1) have contacts or connectors (31) to establish the electrical connection of successive boards when a lighting panel is conformed or to connect an electrical supply source.

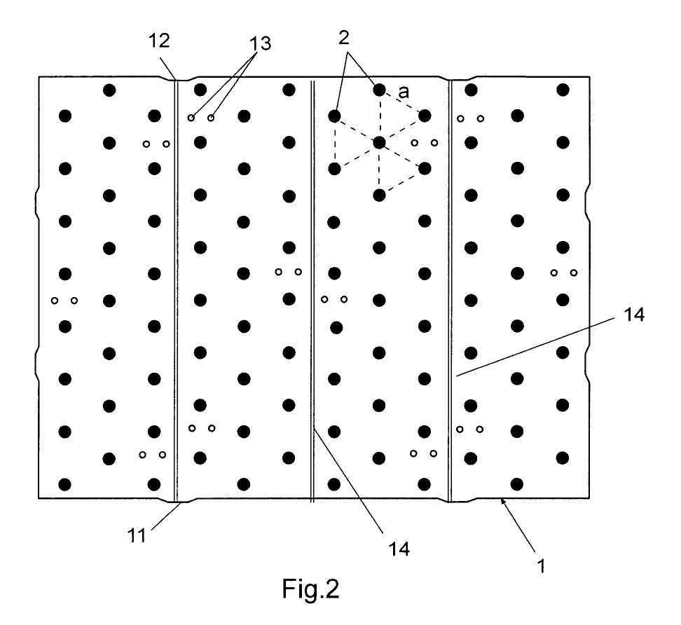

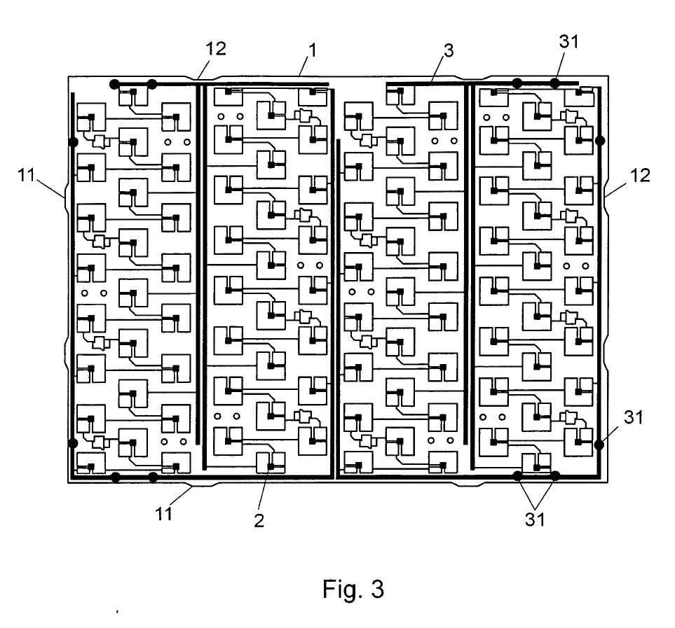

As shown in the example of embodiment in FIG. 2, the boards (1) can be equipped with tear lines (14) defined by scored lines of material, to ease the controlled separation of the board (1) into usable pieces of varying dimensions, said tear lines being distributed in such a way that each of the portions of board has a group of diodes (2) connected electrically by the conductive tracks of a printed circuit (3).

Having sufficiently described the nature of the invention, as well as an example of preferred embodiment, it is hereby certified that the materials, form, size and arrangement of the described elements will be able to be modified, only when it does not suppose an alteration of the essential characteristics of the invention that are claimed hereafter.

1. Modular backlighting device comprising:
at least one housing board, said at least one housing board holding a plurality of light emitting diodes; and
a plurality of printed circuits having respective conductive tracks arranged on said at least one housing board, said plurality of light emitting diodes being connected electrically with the respective tracks of said respective plurality of printed circuits;
said plurality of light emitting diodes being arranged on said at least one housing board according to an equilateral triangular distribution wherein each of said respective plurality of light emitting diodes are separated by a fixed distance “a”;
said plurality of light emitting diodes projecting beams of light that converge from a certain distance “d” of the at least one housing board, providing a mass of even light, without dark areas or shadows.

2. Device according to claim 1, wherein said at least one board further comprises:
interlocking outer sections and inner sections for guiding, centering, and connecting additional like boards for creating a lighting panel.

3. Device according to claim 1, wherein said at least one board further comprises:
openings for assembly on any surface by means of clamps, screws or other conventional means.

4. Device, according to claim 1, wherein the plurality of printed circuits further comprises:
at least one contact or connectors for the electrical connection to additional like boards and/or with an electrical supply.

5. Device according to claim 2, wherein the plurality of light emitting diodes maintain the equilateral triangular distribution and the fixed separation “a” in the position of connection of said additional like boards.

6. Device according to claim 1 wherein said at least one board further comprises:
tear lines defined by scored areas of said at least one board, said tear lines allowing for the controlled separation of the at least one board into a plurality of boards having varying dimensions, said respective plurality of boards each having said plurality of light emitting diodes connected electrically by the respective conductive tracks of the plurality of printed circuits.
